(19) United States
(12) Patent Application Publication
(10) Pub. No.: US 2015/0211628 A1
(43) Pub. Date: Jul. 30, 2015

(54) SYSTEM FOR DETECTING POSITIONS OF A MOVABLE BODY FOR SELECTING GEARS

(71) Applicants: ELECTRICFIL AUTOMOTIVE, MIRIBEL CEDEX (FR); ELECTRICFIL CORPORATION, Livonia, MI (US)

(72) Inventor: David CLARK, Madison, AL (US)

(21) Appl. No.: 14/608,526

(22) Filed: Jan. 29, 2015

Related U.S. Application Data
(60) Provisional application No. 61/933,006, filed on Jan. 29, 2014.

(30) Foreign Application Priority Data
Feb. 14, 2014 (FR) 1451171

(51) Int. Cl. F16H 59/10; G01B 7/30; G01B 7/00; G01D 5/12

(52) U.S. Cl. CPC F16H 59/105; G01D 5/12; G01B 7/30; G01B 7/003

(57) ABSTRACT

The invention relates to a system for detecting determined positions of a movable body for selecting gears of a gearbox, the movable body being coupled to move with a plate that is suitable for moving relative to a stationary support supported by the movable body.

According to the invention, the system comprises:
a resistive sensor (6) for determining the position of the plate relative to the support; and
a contactless sensor (7) for determining the position of the plate relative to the support.

The subject matter of the invention lies in the technical field of sensors adapted to identify different linear or angular positions occupied by a movable body in the broad sense.

More precisely, the subject matter of the invention relates to the technical field of magnetic or inductive type sensors for detecting the positions of a movable body.

The subject matter of the invention finds a particularly advantageous application in the field of motor vehicles for the purpose of being fitted to an automatic gearbox in order to detect the gears selected by an operator.

In the preferred technical field of the invention, various positions of an automatic gearbox are selected using a control lever that is generally moved along a straight line by an operator. Such a lever enables various different positions to be selected, such as, for example: a stop position, a reverse position, a neutral position, and various forward travel positions. In conventional manner, the selector lever acts on a hydraulic control rod or slider arranged in a hydraulic circuit for the purpose of selecting the desired position of the automatic gearbox.

In the prior art, various technical solutions have been proposed for identifying the different positions occupied by the selector lever or the control slider. For example, patent U.S. Pat. No. 5,307,013 describes a position sensor having a movable coder connected to a controlling rotary shaft. The coder is implemented in the form of a plate possessing a plurality of code tracks extending concentrically about the rotary shaft. Each of the tracks is made up of magnetic poles with north and south coding. The code elements are arranged on the tracks in such a manner that sensor detection cells, mounted in register with the code tracks, deliver a different combination of binary signals for each determined position of the movable body.

Such a sensor makes it possible to identify the various linear positions taken by a movable body such as a selector lever for an automatic gearbox on the basis of different combinations of binary signals. The magnetic sensor presents the advantage of operating without relative mechanical friction between the coder and the detector cells.

Nevertheless, installing that type of sensor is found to be difficult to perform well, given the small volume available for receiving it. Furthermore, in the event of the information delivered by the sensor failing or being unavailable, the position of the rotary shaft is no longer known.

The present invention seeks to remedy the drawbacks of the prior art by proposing a system for detecting determined positions of a movable body for selecting gears of a gearbox, the system being capable of delivering information about the position of the movable body regardless of operating contingencies of the position sensor, while occupying little space.

To achieve this object, the invention proposes a system for detecting determined positions of a movable body for selecting gears of a gearbox, the movable body being movable along a travel axis while being coupled to move with a plate that is suitable for moving relative to a stationary support supported by the movable body, the system comprising:
a resistive sensor for determining the position of the plate relative to the support; and
a contactless sensor for determining the position of the plate relative to the support.

In particular embodiments, the system of the invention may also present one and/or the other of the following additional characteristics:
the resistive sensor determines the rotary position of the plate relative to the support, and the contactless sensor determines the rotary position of the plate relative to the support; and
the resistive sensor comprises at least two electrical wipers carried by the support and in contact with electrical measurement tracks arranged on the plate parallel to the travel axis, with one of the tracks comprising an electrically conductive portion and an electrically non-conductive portion.

In one aspect, the invention thus provides a system designed to deliver continuously a relatively accurate first information concerning the position of the movable body with the help of a contactless sensor and less accurate second information concerning the position of the movable body with the help of a resistive sensor. In the event of the contactless sensor malfunctioning, the system of the invention guarantees that information concerning the position of the movable body is still delivered, even if this information presents a lower degree of accuracy than the information normally delivered by the contactless sensor.

Another object of the invention is to guarantee proper operation of the resistive sensor in spite of the constraints associated firstly with the small dimensions for receiving the sensor, and secondly with the back-and-forth movement of the movable plate.

To achieve this object, the system of the invention for detecting determined positions of a movable body for selecting gears of a gearbox comprises an electrical contact wiper including a first bend defining on one side a fastener branch for fastening to the support and on the opposite side a contact branch for contacting the measurement track, the contact branch extending facing the fastener branch and presenting a determined length up to a free end, which determined length is preferably less than the length of the fastener branch.

In addition, the system of the invention may also present one or more or all of the following additional characteristics:
the contact branch of the electrical wiper includes a second bend between the first bend and the free end, the second bend having a concave side facing towards the fastener branch and presenting, on its side opposite from its concave side, a convex surface for contacting the electrical measurement track;
the second bend of the contact branch of the electrical wiper defines on one side a terminal portion, and on the opposite side an intermediate portion forming an angle relative to the terminal portion that lies in the range 180° to 90°;
the contact branch of the electrical wiper includes a third bend between the first bend and the second bend, the third bend having a convex side facing towards the fastener branch;
the contact branch of the electrical wiper includes a cutout extending from its free end such that the contact branch presents two prongs over a fraction of its length;
the fastener branch of the electrical wiper is mounted on the support with the help of a positioning guide member;
the electrical wipers of the resistive sensor are connected to an electrical power supply; and
the contactless sensor comprises a series of code tracks arranged on the plate parallel to the travel axis, each of the tracks being made up of code elements with a physical magnitude, detector elements being mounted on the support in register with the code tracks and being adapted to deliver a different combination of binary signals for each determined position of the rotary shaft.

Various other characteristics appear from the following description made with reference to the accompanying drawing, which shows embodiments of the invention as non-limiting examples.

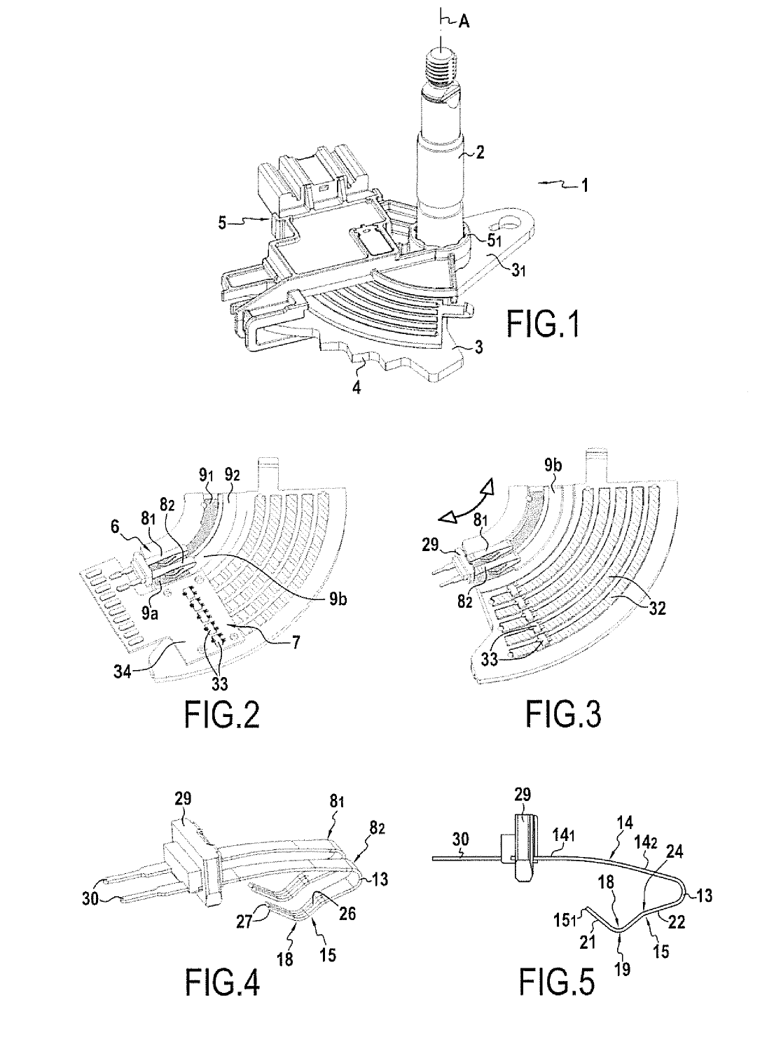

FIG. 1 is a perspective view showing an embodiment of a system in accordance with the invention.

FIG. 2 is a fragmentary perspective view of the system shown in FIG. 1 and serving to show up characteristic elements of the system of the invention.

FIG. 3 is a view analogous to FIG. 2 with the support removed in order to show characteristic elements of the sensors.

FIG. 4 is a perspective view of an embodiment of an electrical contact wiper in accordance with the invention.

FIG. 5 is a side view of the electrical contact wiper in accordance with the invention as shown in FIG. 4.

FIG. 1 shows an embodiment of a system 1 suitable for detecting the positions of a movable body 2 for selecting gears in a vehicle gearbox. The movable body 2 is movable along a travel axis A that may be linear or angular. In a preferred embodiment as shown in the drawing, the movable body is a shaft operated to turn about its own axis A in both directions by means of a lever operated by a user in order to select a gear. This rotary shaft 2 is suitable for occupying a plurality of stable angular positions over a limited angular range, e.g. a range having a value of a little less than 90°. By way of example, the rotary shaft 2 constitutes a control rod inserted in the hydraulic control circuit of an automatic gearbox in the broad sense.

The system 1 has a movable plate 3 constrained or coupled to rotate with the rotary shaft 2. The movable plate 3 thus extends in a plane substantially perpendicular to the rotary shaft 2 over an angular range of about 90° in order to present the shape of one-fourth of a disk. In conventional manner, the movable plate 3 has notches 4 in its outer edge for receiving or housing a gear-indexing finger. Opposite from its outer edge, the movable plate 3 has an extension 3₁ for assembling by any appropriate means with the rotary shaft 2. The movable plate 3 is suitable for turning relative to a stationary support 5 that is supported by the rotary shaft 2. The stationary support 5 is in the form of a box having a ring 5₁ freely engaged around the rotary shaft 2.

In accordance with the invention, the system 1 includes a resistive sensor 6 for determining the position of the movable body 2, and in the example shown for determining the rotary position of the movable plate 3 (i.e. of the rotary shaft 2) relative to the stationary support 5, and a contactless sensor 7 for determining the position of the movable body 2, and in the example shown the rotary position of the movable plate 3 (i.e. of the rotary shaft 2) relative to the stationary support 5. The system 1 is thus suitable for continuously delivering two items of information concerning the position of the rotary shaft 2, one coming from a mechanical reading and the other from a magnetic or inductive reading.

As can be seen more clearly in FIGS. 2 and 3, the resistive sensor 6 has at least two electrical wipers 8₁, 8₂ carried by the stationary support 5, and exactly two wipers in the example shown. The electrical wipers 8₁ and 8₂ are in contact with respective electrical measurement tracks 9₁ and 9₂ formed on the movable plate 3 parallel to the travel axis A. In the example shown in the drawings, the electrical measurement tracks 9₁ and 9₂ are made concentrically about the rotary shaft 2, i.e. the electrical measurement tracks 9₁ and 9₂ are made to occupy concentric circular arcs centered on the rotary shaft 2. When the movable body moves linearly along the axis A, then the electrical measurement tracks 9₁ and 9₂ should be arranged parallel to each other and to the linear travel axis A.

The movable plate 3 thus has a first electrical measurement track 9₁ that is adjacent or closer to the rotary shaft 2. This first electrical measurement track 9₁ comprises an electrically conductive material with which the electrical wiper 8₁ is in contact over the entire turning range of the movable plate 3.

The movable plate 3 has a second electrical measurement track 9₂ having at least one electrically conductive portion 9a and at least one electrically non-conductive portion 9b. This second electrical measurement track 9₂ has an electrically conductive portion 9a made out of an electrically conductive material that extends in contiguous manner with the electrically conductive material of the first electrical measurement track 9₁. For example, the first electrical track and the electrically conductive portion 9a of the second electrical track are made of an electrically conductive material carried by the movable plate 3. Under such circumstances, it should be observed that a step or a shoulder appears at the junction between the electrically conductive portion 9a and the electrically non-conductive portion 9b.

The electrical wiper 8₂ is in contact with the second electrical measurement track 9₂ over the entire turning range of the movable plate 3. Thus, while the movable plate 3 is turning, the electrical wiper 8₂ is in contact either with the electrically conductive portion 9a or with the electrically non-conductive portion 9b.

According to an advantageous embodiment characteristic shown more particularly in FIGS. 4 and 5, each electrical wiper 8₁ and 8₂ has a first bend 13 defining on one side a fastener branch 14 for fastening to the stationary support 5 and on the opposite side a contact branch 15 for making contact with the measurement track in association with which it extends. The contact branch 15 extends facing the fastener branch 14 and presents a length to a free end 15₁ that is preferably less than the length of the fastener branch 14. By way of example, and as can be seen clearly in FIG. 5, the first bend 13 may present a circularly arcuate profile. The fastener branch 14 preferably includes a substantially rectilinear portion 14₁ extending up to the first bend 13 via a curved portion 14₂. This curved portion 14₂ and the contact branch 15 thus converge towards the first bend 13. The curved portion 14₂ and the contact branch 15 present between them an acute angle which may for example lie in the range 0° to 90°, and may for example be about 15°. This configuration for the electrical wiper makes it possible to obtain a spring effect causing the contact branch 15 to bear continuously against the electrical track while presenting a size that is limited since the fastener branch 14 and the contact branch 15 extend facing each other.

According to an advantageous embodiment characteristic, the contact branch 15 of the electrical wiper includes a second bend 18 between the first bend 13 and the free end 15₁ of the contact branch, which second bend 18 has its concave side facing towards the fastener branch 14. The second bend 18 presents a convex surface 19 opposite from its concave side for making contact with the electrical measurement track. This convex surface 19 serves to obtain good electrical contact between the electrical wiper and the electrical measurement track.

In a preferred embodiment, the second bend 18 of the contact branch 15 of the electrical wiper defines on one side a terminal portion 21 and on the other side an intermediate portion 22 forming an angle of about 110° with the terminal portion 21. This intermediate portion 22 extends as far as the first bend 13. In the embodiment shown, a third bend 24 with a convex side facing towards the fastener branch 14 is provided in this intermediate portion 22. Thus, the contact branch 15 of the electrical wiper includes a third bend 24 between the first bend 13 and the second bend 18.

In a preferred variant embodiment, the contact branch 15 of the electrical wiper includes a cutout 26 extending from its free end 15₁ in such a manner that the contact branch presents two prongs 27 over a fraction of its length. Advantageously, this cutout 26 extends beyond the second bend 18 in order to arrange the two prongs 27 so that they provide two contact surfaces with the electrical measurement track, thereby guaranteeing good contact therewith.

In an advantageous variant embodiment, each fastener branch 14 of the electrical wiper is mounted on the stationary support 5 with the help of a positioning guide member 29. By way of example, the positioning guide member 29 is molded over the substantially rectilinear portion 14₁ of the fastener branch 14 and it has slide type mounting means for mounting on the stationary support 5. Starting from the positioning guide member 29 and remote from the first bend 13, the fastener branch 14 presents connection tabs 30 for connection to an electrical power supply.

The operation of the resistive sensor 6 stems directly from the above description. The resistive sensor 6 delivers information corresponding to the angular position of the movable plate 3 or of the rotary shaft 2 while the electrical wiper 8₁ is in contact with the first electrical measurement track 9₁ and the electrical wiper 8₂ is in contact with the electrically conductive portion 9a of the second electrical measurement track 9₂. When the electrical wiper 8₁ is in contact with the first electrical measurement track 9₁ while the electrical wiper 8₂ is in contact with the electrically non-conductive portion 9b of the second electrical measurement track 9₂, then the resistive sensor does not deliver any information for some other determined angular position of the movable plate 3 or of the rotary shaft. The resistive sensor 6 serves to provide information about the position of the rotary shaft regardless of the position information delivered by the contactless sensor 7.

The contactless sensor 7 has a series of code tracks 32 arranged on the movable plate 3 concentrically relative to one another about the rotary shaft. The code tracks 32 are five in number in the example shown and they are implemented as concentric circular arcs centered on the rotary shaft 2. The code tracks 32 are preferably arranged on the movable plate 3 in such a manner that the electrical measurement tracks 9₁ and 9₂ are situated between the rotary shaft 2 and the code tracks 32. Each of the code tracks 32 is made up of code elements presenting a respective physical magnitude.

Detector elements 33 are mounted on the support in register with the code tracks, and in particular on a printed circuit 34 housed in the stationary support 5. In known manner, each detector element 33 is mounted in register with a respective code track 32. The detector elements 33 are five in number in the example shown and they are adapted to deliver a different combination of binary signals for each determined position of the rotary shaft. In a preferred embodiment, the position sensor 7 is of the magnetic type, such that the code elements possess a magnetic nature and the detector elements 33 are magnetic detector cells, such as Hall effect cells, for example. Naturally, the subject matter of the invention may be applied to a position sensor 7 using some other physical magnitude. Thus, the sensor may be of the inductive type, so that the code tracks 32 are formed by inductive type code elements, while the detector elements 33 are inductive type detector elements.

In conventional manner, the detector elements 33 are sensitive to the value of the physical magnitude of the code elements, such that each detector element 33 occupies:
a first binary state when the value of the physical magnitude is less than a threshold;
a second binary state when the value of the physical magnitude is greater than said threshold; and
a determined binary state (first or second) when said detector elements are not situated facing a code track.

The system of the invention thus makes it possible in normal operation to deliver first position information coming from the contactless sensor and second position information coming from the electrical contact sensor. In the event of the contactless sensor malfunctioning, the system of the invention continues to deliver position information as delivered by the contact sensor, even if this information is less accurate than the information usually delivered by the contactless sensor.

In the embodiment shown in the figures, the system 1 of the invention is designed to detect the angular positions of the movable body 2. As mentioned above, the system 1 is adapted to detect the positions of the movable body 2 that moves along a linear travel axis A. In this variant embodiment, the resistive sensor 6 and the contactless sensor 7 are adapted to determine the linear positions of the plate 3 relative to the support 5.

The invention is not limited to the examples described and shown since various modifications may be made thereto without going beyond its ambit.

1. A system for detecting determined positions of a movable body (2) for selecting gears of a gearbox, the movable body (2) being movable along a travel axis (A) while being coupled to move with a plate (3) that is suitable for moving relative to a stationary support (5) supported by the movable body, the system being characterized in that it comprises:
a resistive sensor (6) for determining the position of the plate relative to the support; and
a contactless sensor (7) for determining the position of the plate relative to the support.

2. A system according to claim 1, characterized in that the resistive sensor (6) determines the rotary position of the plate relative to the support, and in that the contactless sensor (7) determines the rotary position of the plate relative to the support.

3. A system according to claim 1, characterized in that the resistive sensor (6) comprises at least two electrical wipers (8₁, 8₂) carried by the support and in contact with electrical measurement tracks (9₁, 9₂) arranged on the plate parallel to the travel axis, with one of the tracks comprising an electrically conductive portion and an electrically non-conductive portion.

4. A system according to claim 3, characterized in that the electrical contact wiper includes a first bend (13) defining on one side a fastener branch (14) for fastening to the support (5) and on the opposite side a contact branch (15) for contacting the measurement track, the contact branch extending facing the fastener branch and presenting a determined length up to a free end, which determined length is preferably less than the length of the fastener branch.

5. A system according to claim 4, characterized in that the contact branch (15) of the electrical wiper includes a second bend (18) between the first bend (13) and the free end (15₁), the second bend (18) having a concave side facing towards the fastener branch and presenting, on its side opposite from its concave side, a convex surface (19) for contacting the electrical measurement track.

6. A system according to claim 5, characterized in that the second bend (18) of the contact branch (15) of the electrical wiper defines on one side a terminal portion (21), and on the opposite side an intermediate portion (22) forming an angle relative to the terminal portion (21) that lies in the range 180° to 90°.

7. A system according to claim 4, characterized in that the contact branch (15) of the electrical wiper includes a third bend (24) between the first bend (13) and the second bend (18), the third bend (24) having a convex side facing towards the fastener branch.

8. A system according to claim 4, characterized in that the contact branch (15) of the electrical wiper includes a cutout (26) extending from its free end (15₁) such that the contact branch (15) presents two prongs (27) over a fraction of its length.

9. A system according to claim 4, characterized in that the fastener branch (14) of the electrical wiper is mounted on the support with the help of a positioning guide member (29).

10. A system according to claim 3, characterized in that the electrical wipers (8₁, 8₂) of the resistive sensor (6) are connected to an electrical power supply.

11. A system according to claim 1, characterized in that the contactless sensor (7) comprises a series of code tracks (32) arranged on the plate (3) parallel to the travel axis, each of the tracks (32) being made up of code elements with physical magnitude, detector elements (33) being mounted on the support in register with the code tracks (32) and being adapted to deliver a different combination of binary signals for each determined position of the rotary shaft (2).
